(19) United States
(12) Patent Application Publication
(10) Pub. No.: US 2010/0111816 A1
(43) Pub. Date: May 6, 2010

(54) INORGANIC PARTICLE-CONTAINING EMULSION AND MANUFACTURING METHOD OF A PARTICLE BY USING THE INORGANIC PARTICLE-CONTAINING EMULSION

(75) Inventors: Koji Aga, Chiba (JP); Hiromichi Kobayashi, Chiba (JP)

Correspondence Address: GREENBLUM & BERNSTEIN, P.L.C., 1950 ROLAND CLARKE PLACE, RESTON, VA, 20191, US

(73) Assignee: POWDERTECH CO., LTD., Chiba (JP)

(21) Appl. No.: 12/532,755

(22) PCT Filed: Feb. 21, 2008
(86) PCT No.: PCT/JP2008/052955

§ 371 Date: Dec. 7, 2009

(30) Foreign Application Priority Data
Mar. 30, 2007 (JP) 2007-094077

(51) Int. Cl. C01B 31/14

(52) U.S. Cl. 423/449.8

(57) ABSTRACT

The invention aims at providing an inorganic particle-containing emulsion which enables further size reduction of particles and can bring about a mono-disperse system and an enhanced yield and a manufacturing method of a particle by the use of the emulsion. This aim can be performed by a water in oil emulsion prepared by mixing an oil phase liquid and an water phase liquid which contains inorganic particles under agitation, in which the water phase liquid contains inorganic particle having a specific gravity of 1.5 to 11 g/cm³ and 0.5 to 5 wt % of agar-agar as calculated by taking the quantity of water contained in the water phase liquid as 100 wt % and the oil phase liquid contains hydrophobic particles as a dispersion stabilizer and in which the water phase liquid is present as the dispersion phase of the water in oil emulsion with the inorganic particles dispersed in the organic particle-containing emulsion; and a manufacturing method of a particle which contains both inorganic particle and agar-agar by the use of the emulsion.

### TECHNICAL FIELD

The present invention relates to an inorganic particle-containing emulsion which enables to prepare a particle comprising inorganic particles in aiming size through separating, collecting and drying the solid prepared in the inorganic particle-containing emulsion, and a manufacturing method of a particle by using the inorganic particle-containing emulsion.

### BACKGROUND ART

A method comprising pulverizing and classifying coarse particles to manufacture particles, or a method wherein a solution which contains a raw material is made into fine particles to manufacture a solid by drying, etc., or the like are well known for manufacturing particles constituting powders, granules, or the like. Such powder formation methods are used in various product fields including powder metallurgy, pharmaceuticals, cosmetics, etc. In such a field, particles are produced to have required qualities, such as shapes, sizes, etc., in accordance with each application.

For example as for a atomizing process by spray drying, Patent Document 1 discloses a particle formation method in which fine particles of a material to be classified are introduced into a chamber and transported by a dry gas stream and then a powder formation droplets are sprayed to form a particles. Patent Document 2 discloses a powder formation process using a rotating disc spray (disc atomizer) wherein a solid particle dispersed solution is continuously supplied in a spray drying chamber and droplets formed by utilizing the surface tension and centrifugal force of the disc are dried to be a powder. Further, Patent Document 3 discloses a method comprising, forming different kinds of particles by polymerization, homogeneously dispersing the prepared particles in a solvent, followed by evaporating the solvent to manufacture the particles. Furthermore, to manufacture mono-dispersed particles having a small particle sizes in a high yield, Patent Document 4 discloses a manufacturing method of a particle employing the membrane emulsification method in which a membrane material is used when emulsifying an oil phase into a water phase.

Patent Document 1: Japanese Patent Laid-Open No. 2001-070779

Patent Document 2: Japanese Patent Laid-Open No. 2004-082005

Patent Document 3: Japanese Patent Laid-Open No. H05-297632

Patent Document 4: Japanese Patent Laid-Open No. 2006-150340

### DISCLOSURE OF THE INVENTION

### Problems to be Solved by the Invention

In powder materials used in various fields, mono-dispersion and size reduction are further required for the particles. At same time, a manufacturing method of the particles available for material designs in intended use is also required. Further, to minimize the production costs, it is required to up yield. In particular, the materials such as ferrite, dielectric, battery materials etc. they are required a production steps, filling in a mold, sintering, baking or like accompanying volume changes, and when the filling amount is not uniform caused by the deviations in raw material powders, deformation, cracking, pores, deviations in properties etc may be resulted in the product after baking or sintering. In such a background, when the methods, pulverizing and classifying of coarse particles are applied to manufacture fine particles, it is hard to crush particles in uniform size, and the classification to collect fine particles drastically reduces the yield and it may fail to increase the production efficiency. In addition, mono-dispersion of the fine particles may be hardly performed.

When a atomized material is manufactured by the particle formation method disclosed in Patent Document 1, because droplets are formed only by the surface tension of a continuously sprayed powder formation solution, it may tends to show a wide particle size distribution. Further, because the particle size is controlled by the nozzle diameter and the powder formation solution supply, even if the particle diameter is controlled, the particle size distribution may vary depending on conditions. It may result problem that the particle size distribution of the product is broader than the aiming particle size distribution. Furthermore, formed powders may be drawn into a dust filter, etc., to result yield problems.

The method disclosed in Patent Document 2 may provide a wide particle size distribution because a continuously supplied solid particle dispersed solution forms droplets by utilizing the surface tension and disc centrifugal force. In addition, control of the particle size distribution is not easy because it is controlled by the disc rotation and solution supply. As a result, problem in both a yield and wide particle size distribution may come out. Furthermore, smaller size particles are easy to be drawn into a dust filter, etc., just after they are dried to result yield problem also.

In the method disclosed in Patent Document 3, particles are first prepared by agitation of a dispersant homogeneously dispersed in a solvent for polymerization and the solvent is dried to finish. Next, a salting agent is added while agitating the solution in which the polymer formed by the polymerization reaction is dispersed to cause aggregation of fine particles, and to control the particle size, they are bonded by melting by heating the solution with further continuous agitation. Thus, the agitation state and the specific gravity of a dispersant are the factor affecting on the control of both the particle shape and the size. It means that precious manufacturing of mono-dispersed fine particles is difficult.

The method employing the membrane emulsification disclosed in Patent Document 4 may be difficult in control of the powder formation of the dispersion phase when the oil phase permeate through the membrane for the emulsification with the water phase, because of poor wettability of the membrane material surface against to the dispersion phase. In addition, because clogging of the membrane through pores by the dispersion phase should be prevented by the quality and shape of a membrane material, the state of permeation through the membrane affects on both mono-dispersion ability and yield. It may be a problem to be solved. Further, in the method disclosed in Patent Document 4, forming of extremely smaller emulsion droplets compared to the size of aiming emulsion droplets is required to prevent inorganic substance from settling and assure stabilized emulsion.

Under such circumstances, the object of the present invention is to provide an inorganic particle-containing emulsion which enables further size reduction and mono-dispersion of particles with yield improvement, and a manufacturing method of a particle using such inorganic particle-containing emulsion.

### Means to Solve the Problem

After intending extensive studies, the present inventors employed the following method to solve the above described problems.

The inorganic particle-containing emulsion of the present invention is a water in oil emulsion prepared by mixing an oil phase liquid and a water phase liquid which contains an inorganic particle under agitation, which is characterized in that the water phase liquid contains an inorganic particle having a specific gravity of 1.5 to 11 g/cm³ and 0.5 to 5 wt % of an agar-agar against to 100% of a water contained in the water phase liquid; and the oil phase liquid contains a hydrophobic particle as a dispersion stabilizer, and an inorganic particle is made disperse by making the water phase liquid to be a dispersion phase in the water in oil emulsion.

As for the inorganic particle-containing emulsion of the present invention, it is preferable that the hydrophobic particle is carbon black, hydrophobilized silica, or hydrophobilized titanium oxide.

As for the inorganic particle-containing emulsion of the present invention, it is preferable that the carbon black has a BET specific surface area of 200 m²/g or less and an oil absorption ratio of 100 cc/g or less, and is added in an amount of 0.5 to 10 wt % against to 100% of an oil weight in the oil phase liquid.

The inorganic particle-containing emulsion of the present invention is preferably prepared by adding the oil phase liquid to the water phase liquid gradually under agitation to cause a phase conversion emulsification from an oil in water emulsion (herein after “O/W emulsion”) to a water in oil emulsion (herein after “W/O emulsion”).

As for the inorganic particle-containing emulsion of the present invention, the inorganic particle is one kind or more kinds of an inorganic particle and has an average particle size of 0.01 to 5 μm.

The manufacturing method of a particle of the present invention is a manufacturing method of the particles which contain both inorganic particle and agar-agar by using the inorganic particle-containing emulsion characterized in that the process comprises the steps of: passing of the inorganic particle-containing emulsion through micropores under a constant pressure for size regulation of the emulsion droplets contained in the inorganic particle-containing emulsion, chilling of the droplet size regulated inorganic particle-containing emulsion to make the emulsion droplets gel and prepare a suspension composed of the inorganic particle-containing gel particles and an oil phase liquid which contains a dispersion stabilizer, and removing of the oil phase liquid for separation and collection of the inorganic particle-containing gel particles, followed by dehydration-drying to manufacture particles which contain both inorganic particle and agar-agar.

As for the manufacturing method of the particle of the present invention, it is preferable in the separation to collect the inorganic particle-containing gel particles, an oleophilic organic solvent is added to the suspension under agitation to accelerate settling of the inorganic particle-containing gel particles, and then the inorganic particle-containing gel particles are separated and collected from the oil phase liquid

As for the manufacturing method of the particle of the present invention, it is preferable that the oleophilic organic solvent is toluene, hexane, or methyl ethyl ketone.

As for the manufacturing method of a particle of the present invention, it is preferable that the dehydration-drying process comprises the steps of: dispersing of the rinsed inorganic particle-containing gel particles in an alcohol selected from the group consisting of methanol, ethanol and propanol to form a gel particle dispersed slurry, removing of the moisture contained in the inorganic particle-containing gel particles by the alcohol, subjecting of the gel particle dispersed slurry to the solid-liquid separation to collect the moisture-free dehydrated particles, and removing of the alcohol from the dehydrated particles by air-drying to manufacture particles which contain both inorganic particle and agar-agar.

As for the manufacturing method of a particle of the present invention, it is preferable that the solid content of the inorganic particle-containing emulsion to be passed through micropores is 5 to 30 wt % against to 100% of the inorganic particle-containing emulsion.

### ADVANTAGES OF THE INVENTION

The inorganic particle-containing emulsion of the present invention is a W/O emulsion in which dispersability of the inorganic particle in the water phase liquid is enhanced and the dispersion stability of the emulsion droplets after the emulsification can be maintained also because the water phase liquid as a dispersion phase contains agar-agar to adjust viscosity of the water phase liquid. In addition, as the hydrophobic particles are contained as a dispersion stabilizer in the oil phase liquid, which is a dispersion medium, it makes maintenance of dispersability of the emulsion droplets which contains inorganic particles having a high specific gravity assure to inhibit gathering of the emulsion droplets and result dispersion stability. Further, the manufacturing method of a particle of the present invention enables production of uniform fine particles in a high yield, i.e. less production loss compared to the conventional methods. Furthermore, the manufacturing method of a particle of the present invention enables to minimize waste solution and energy consumption compared to the conventional production methods such as dry process, etc.

### BEST MODE FOR CARRYING OUT THE INVENTION

The present inventors studied a method for manufacturing particle size regulated powders having aimed uniform size in almost mono-dispersed, and finally thought out the method to manufacture uniform particles by utilizing the dispersion state of the emulsion. Then, the best mode for both the inorganic particle-containing emulsion and the manufacturing method of a particle using the inorganic particle-containing emulsion of the present invention will be described.

The manufacturing method of a particle of the present invention is to manufacture particles by making a W/O inorganic particle-containing emulsion pass through micropores to regulate the droplet size of emulsion droplets to an aiming size, followed by drying the droplet size regulated emulsion droplets.

### Inorganic Particle-Containing Emulsion:

The inorganic particle-containing emulsion of the present invention is a W/O emulsion prepared by mixing an oil phase liquid which contains hydrophobic particles as a dispersion stabilizer into a water phase liquid which contains both inorganic particle and agar-agar under agitation. A W/O emulsion is composed of the oil phase as a dispersion medium and the water phase as a dispersion phase.

It is one of the features of the inorganic particle-containing emulsion of the present invention in which the water phase liquid contains an inorganic particle having a specific gravity of 1.5 to 11 g/cm³, and further contains 0.5 to 5 wt % of an agar-agar against to 100% of a water to disperse the inorganic particles in the water phase liquid.

The inorganic particle contained in the water phase liquid has a specific gravity of 1.5 to 11 g/cm³. Because the inorganic particle-containing emulsion of the present invention is enhanced in dispersability of the inorganic particle having a specific gravity higher than water which tends to settle down and it enables to use such particles. However, when a specific gravity of the inorganic particle is less than 1.5 g/cm³, it is difficult to adjust the viscosity in combination with the agar-agar content. In contrast, when a specific gravity of an inorganic particle is greater than 11 g/cm³, it may easily settle down and requires excess amount of agar-agar to be added to prevent the inorganic particle from settling down in the water phase liquid. As a result, it causes an excessively high viscosity in emulsion and it makes rather hard to disperse the inorganic particles in the water phase liquid. Further, such high viscous inorganic particle-containing emulsion is not suitable in processing of the particle production method to be described later because of the poor process ability when the emulsion is made pass through micropores. When both the applicability of the particle production method to be described later and assurance of the particle dispersability are considered, the inorganic particle to be contained in the inorganic particle-containing emulsion is preferred to have a specific gravity of 9 g/cm³ or less.

The inorganic particle is preferred to be composed of any one or more of metal particle, metal-coated particle, metal oxide particle, metal salt, metal hydroxide and fine resin particle. As for example of the inorganic substance constituting the inorganic particle, copper, silver, nickel, magnetite, iron (III) oxide, manganomanganic oxide, manganese dioxide, copper (II) oxide, zinc oxide, titanium oxide, silica, alumina, magnesium oxide, strontium carbonate, calcium carbonate, magnesium carbonate, lithium carbonate, barium carbonate, magnesium hydroxide, calcium hydroxide, calcium sulfate, barium sulfate, etc can be disclosed. In particular, copper particle, silver particle, nickel particle, magnetite particle, iron (III) oxide particle, and titanium oxide particle prepared by the wet synthesis are preferable as materials to be dispersed in the water phase liquid, because they have a small particle diameter.

The inorganic particle is preferred to have an average particle size of 0.01 to 5 μm. When the inorganic particle has an average particle size of less than 0.01 μm, the viscosity of the water phase liquid (dispersion phase) is increased to make it not suitable to form emulsion with the oil phase liquid (dispersion medium). On the other hand, when an average particle size exceeds 5 μm, the inorganic particle may tend to settle down. As a result, it makes difficult to assure the dispersability. So, the inorganic particle is preferred to have an average particle size of 0.1 to 3.5 μm.

The average particle size disclosed in the present application is measured by using a Microtrac Particle Size Analyzer (Model 9320-X100) manufactured by NIKKISO Co., Ltd. The dispersion medium used is water. 10 g of sample and 80 ml of water are put into a 100 ml beaker, and 2 to 3 drops of a dispersant (hexasodium metaphosphate) is added thereto. Then, the dispersion process is carried out for 20 seconds at a power level of 4, using the Ultrasonic Homogenizer (model UH-150 manufactured by SMT. Co., LTD.). After that, a form generated on the surface portion in the beaker is removed, and to measure the average particle size, the sample is put into the analyzer.

The agar-agar content is preferable to be 0.5 to 5 wt % against to 100 wt % of water contained in the water phase liquid. When agar-agar content is less than 0.5 wt %, the effect to assure the dispersability of the inorganic particle in the water phase liquid is not sufficient. In addition, the shape stability of the emulsion droplets which contains the inorganic particle is made poor due to the low viscosity of the water phase liquid. On the other hand, when the agar-agar content is greater than 5 wt %, the viscosity of emulsion may be too high to make it difficult to disperse the inorganic particles in the water phase liquid.

The kind of agar-agar is not limited, and may be those manufactured from any raw materials such as agar weed, Ceylon moss, Pterocladia capillacea, etc. The agar-agar can be used in any forms of powder shaped agar-agar, flak shaped agar-agar, block shaped agar-agar, angular shaped agar-agar and string shaped agar-agar. However, powder shaped agar-agar is preferable due to the good water absorbability when productivity is considered.

The preferably arranged viscosity of the water phase liquid by adding agar-agar enables to assure the dispersability of the inorganic particle in the water phase liquid and will also make the shape of the emulsion droplets stable, i.e. a W/O emulsion having good dispersion stability can be prepared. Further, in the particle production method to be described later, because the emulsion droplets are made to be gel when the inorganic particle-containing emulsion is chilled, the inorganic particle-containing gel particle can maintain the shape formed as a droplet composed of the water phase liquid. As a result, the shape of gel particle which contains inorganic particles can be maintained by the temperature control to make shelf life of the emulsion long easily.

The viscosity of the water phase liquid is preferred to be in the range from 10 to 100 cp. The viscosity of the water phase liquid affects on both the size and shape stability of the emulsion droplets. The water phase liquid having a viscosity less than 10 cp may not perform the shape stability of the emulsion droplets. On the other hand, water phase liquid having a viscosity greater than 100 cp may tend to make an emulsion droplet large. It means that higher viscosity is not preferable to manufacture the particles in an aiming size in the manufacturing method of a particle of the present invention.

The method for preparing the water phase liquid will be described. First, pure water is put into the vessel of an agitator, followed by adding an inorganic powder. However, when the viscosity is high, a dispersant may mixed together and agitation will be carried out for 1 to 3 hours to prepare water-based slurry. The agitation is carried out by using an agitator which causes a strong shearing force, e.g., homogenizer, homomixier, TK Filmix (PRIMIX), etc. The solid content of the prepared water slurry is adjusted to be in the range from 10 to 55 wt % by using pure water, and agar-agar is added thereto, followed by mixing for 5 to 10 minutes under agitation. The water phase liquid is prepared by dissolving the agar-agar and adjusting the water content to make the solid content of the water slurry to be in the range from 5 to 40 wt % against to 100 wt % of the water slurry through evaporation by heating the prepared water slurry at 70 to 90° C. with agitation. After finishing the processing, a dispersant is added to adjust the viscosity of the water phase liquid to be 100 cp or less. As for a preferable dispersant, polycarboxylic acid polymer surfactant, condensed naphthalenesulfonic acid ammonium salt, etc can be exemplified. The prepared water phase liquid is maintained at 90° C. in a vessel to prevent the agar-agar made to be gel, and the agitation is continued to maintain the dispersion of both the emulsion droplets and the inorganic particles in the emulsion droplets.

The oil phase liquid contains an oil component and hydrophobic particles as a dispersion stabilizer. Vegetable oil should be used as the oil component because they can make adjustment of the viscosity and removal of the oil component easy. As for vegetable oils, any of lecithin, soybean oil, salad oil, edible safflower oil, sunflower oil, rapeseed oil, corn oil, rice oil, arachis oil, olive oil, sesame oil, linseed oil, coconut oil, palm oil, copra oil, blended oil, etc can be applicable.

In general, the dispersion stabilizer may not be required to add when the dispersability of the oil phase liquid which performs as a binder component is excellent. However, when small emulsion droplets should be prepared, the specific surface area of the emulsion droplets may become large and it tends to cause aggregation and/or uniting. When a dispersion stabilizer is added in such a case, hydrophobic particles having a small particle diameter and a large specific surface area are made disperse in the oil phase liquid to perform steric obstruction among the emulsion droplets to maintain the emulsion droplets dispersed. As a result, a W/O emulsion with good dispersion stability can be prepared by preventing the uniting and aggregation among the emulsion droplets to result improved dispersability. Preferable dispersion stabilizer is a hydrophobic particle having a small particle size and a large specific surface area. In addition, a colored hydrophobic particle is more preferable because the removal degree of the oil phase liquid can be easily confirmed in the particle production step.

The hydrophobic particle used as a dispersion stabilizer is preferred to be one selected from carbon black, hydrophobilized silica and hydrophobilized titanium oxide. These hydrophobic particles are preferred to be those having a BET specific surface area in the range from 3 to 200 m²/g, when the viscosity of the oil phase liquid is considered. Particularly, carbon black is preferable because of easy handling, a large specific surface area and less expensive.

When carbon black is used as a dispersion stabilizer, it is preferable to use those having a BET specific surface area of 200 m²/g or less and an oil absorption ratio of 100 cc/g or less and is added in an amount of 0.5 to 10 wt % against to 100 wt % of the oil content in the oil phase liquid. When a hydrophobic particle having a BET specific surface area greater than 200 m²/g is used, the viscosity of the oil phase liquid may increase and hence such a hydrophobic particle is not suitable for forming of the emulsion droplets having an aiming droplet size, in relation to the water phase liquid. When carbon black having an oil absorption ratio greater than 100 cc/g is used, the viscosity of the oil phase liquid tends to increase to make it difficult to form the emulsion droplets of an aiming droplet size. Further, when 0.5 to 10 wt % of carbon black is added against to 100 wt % of the oil content in the oil phase liquid, a good suspension state can be achieved to make adjustment of the viscosity and the removal thereof to be carried out later easy. More preferable amount of carbon black to be added is in the range from 2 to 6 wt %.

The BET specific surface area of the hydrophobic particle is measured by using an Automatic Surface Area Analyzer GEMINI2360 (manufactured by Shimadzu Corporation). The measurement tube used comprises a straight pipe having outer diameter of 9.5 mm, a sample vessel having outer diameter of 19 mm, a length of 38 mm, and a sample capacity of about 6.0 cm³. Before the measurement, measurement tube is post baked at 200° C. for 1 hour under nitrogen atmosphere. About 0.5 g of the hydrophobic particle sample is put into the measurement tube, a measurement tube which contains a sample is precisely weighed by using a precision balance and then is set to the analyzer and is made to adsorb N₂ gas to measure the amount of gas adsorbed. The measurement is carried out by the one-point method, and the BET specific surface area is automatically calculated when the weight data of N₂ gas adsorbed sample is input after finishing measurement.

The oil absorption ratio of carbon black disclosed in the present application is DBP oil absorption. The DBP oil absorption is a value measured according to the specification described in JIS K-6217-4, “Carbon black for rubber industry—Fundamental characteristics—Part 4: Determination of oil absorption”, using Absorptometer Type-A.

As the carbon black is added to the oil phase liquid, the carbon black dispersed among the oil phase liquid performs as a dispersion stabilizer. The hydrophobic carbon black performs steric obstruction among the emulsion droplets to maintain the emulsion droplets dispersing and prevent the emulsion droplets from uniting and aggregating each other. As a result, a W/O emulsion having good dispersion stability can be prepared. In addition, the present inventors have found out that when carbon black is contained in the oil phase liquid, it performs effect preventing of the emulsion from clogging in micropores when it is made pass through. Detail will be described in the production method of a particle.

As the viscosity of the oil phase liquid is adjusted together with the viscosity of the water phase liquid in consideration of the aiming emulsion droplet size, but it is preferred to be in the range from 50 to 1000 cp at room temperature (23° C.). By the way, the specific gravity of the emulsion droplet is high because the inorganic particle-containing emulsion of the present invention contains the inorganic particle in the water phase liquid. So, when the viscosity of the oil phase liquid is less than 50 cp, stabilized emulsion droplets of about 1 to 1000 μm cannot be prepared. On the other hand, the oil phase liquid having a viscosity greater than 1000 cp makes the emulsion droplet difficult to be small, and is not suitable for preparing the particle of an aiming size in the manufacturing method of a particle of the present invention.

The method for preparing the oil phase liquid will be described. The oil phase liquid is prepared by putting a vegetable oil into a vessel, adding hydrophobic particles as a dispersion stabilizer thereto to be a content in the range from 0.5 to 10 wt % against to 100 wt % of the vegetable oil, followed by agitation of these components at least 3 minutes by using a homogenizer to disperse the hydrophobic particles in the vegetable oil. The temperature of the oil phase liquid may be adjusted to a temperature equal to that of the water phase liquid (90° C.).

The method for preparing the inorganic particle-containing emulsion will be described. The volume mixing ratio of the water phase liquid against to the oil phase liquid in the inorganic particle-containing emulsion is preferred to be [water phase liquid]:[oil phase liquid] of 1:1 to 1:4. The inorganic particle-containing emulsion of the present invention should be a W/O emulsion prepared by mixing an oil phase liquid and a water phase liquid. However, it is preferable to start agitation when just the water phase liquid is put into an agitation vessel to maintain the dispersion state of the inorganic particle with agar-agar in the water phase liquid.

In the method for preparing the inorganic particle-containing emulsion, it is preferable to adopt a phase conversion emulsification from an O/W emulsion to a W/O emulsion as described later, because the emulsion droplets are prevented from uniting each other and it enables to assure a good dispersion state. Specifically, using an agitator comprising an agitation blade capable for agitating the entire reaction vessel, the dropwise oil phase liquid is gradually added to the water phase liquid stored in the vessel under agitation while maintained at 90° C. At the time when the amount of oil phase liquid exceeds the amount of water phase liquid, the dispersion medium is made convert from the water phase to the oil phase to be a W/O emulsion.

In the conversion emulsification step, it is preferable to manage the rotation of agitation blade in accordance with viscosity changes of the mixed solution associated with the progress of the emulsification in order to make the added dropwise oil phase liquid disperse in the water phase liquid uniformly. It is because that too strong agitation against to the viscosity of the mixed solution tends to result a smaller emulsion droplet size than aiming. In contrast, too weak agitation tends to result a larger emulsion droplet size than aiming. So, the agitation strength should be arranged to manage the droplet size of emulsion droplets. From starting point, the number of rotation will be increased in accordance with the increasing of viscosity of mixed solution caused by adding of the oil phase liquid, and then the rotation will be decreased in accordance with the decreasing of viscosity caused by forming of emulsion droplets in the entire mixed solution (emulsion).

The prepared W/O emulsion has the water phase liquid as a dispersion phase dispersed in the form of emulsion droplet, and the emulsion droplets contain agar-agar and inorganic particle together with the water. The number of inorganic particle contained in the emulsion droplet is affected by the dispersion state of the inorganic particle in the water phase liquid, the size of emulsion droplet, and the agitation strength during the emulsification. The emulsion droplets of the W/O emulsion prepared under the above-mentioned emulsification conditions has an average droplet size in the range from 10 to 1000 μm. The inorganic particle-containing emulsion of the present invention is particularly suitable for efficiently manufacturing the emulsion droplets which contains inorganic particles having uniform droplet size in the range from 10 to 300 μm.

To perform phase conversion emulsification, it is preferable to use an agitator capable of agitating the entire reaction vessel. This is because the agitation of the entire reaction vessel enables homogeneous agitation to mix liquids in a short time even when the viscosity of the liquid to be agitated is high. As for an agitator capable, a Full Zone Blade (KOBELCO ECO-SOLUTIONS CO., LTD.) can be considered. The Full Zone Blade is featured in lower power consumption, and it is preferable in the viewpoint of the productivity also.

### Manufacturing Method of a Particle

The manufacturing method of a particle of the present invention is a method wherein the inorganic particle-containing emulsion is made to pass through micropores to regulate the droplet size of the emulsion droplets to an aiming size, the droplet size regulated emulsion is chilled to form an inorganic particle-containing gel particle, followed by separation for collection, and then rinsed and dried to prepare the particle which contains both inorganic particle and agar-agar. The steps will be described below.

step a: The inorganic particle-containing emulsion is made to pass through micropores under constant pressure to regulate the droplet size of emulsion droplets contained in the inorganic particle-containing emulsion.

Step b: the droplet size regulated inorganic particle-containing emulsion is chilled to make the emulsion droplets to be inorganic particle-containing gel particles, and a suspension composed of the inorganic particle-containing gel particles and an oil phase liquid which contains hydrophobic particles as a dispersion stabilizer is prepared.

Step c: the inorganic particle-containing gel particle is collected by separating from the oil phase liquid which contains the hydrophobic particle as a dispersion stabilizer, followed by rinsing and desolventizing of the inorganic particle-containing gel particle.

Step d: the desolventized inorganic particle-containing gel particle is dried by dehydration-drying to manufacture particles which contain both inorganic particle and agar-agar.

The manufacturing method of the particles will be described step by step.

step a: The emulsion droplets in the inorganic particle-containing emulsion described above are regulated. The inorganic particle-containing emulsion used in the manufacturing method of a particle of the present invention has the emulsion droplets with the droplet size which have been already roughly arranged, as described above. However, regulation of the droplet size will be carried out to further regulate the emulsion droplets in an aiming size.

When the inorganic particle-containing emulsion is made to pass through micropores under a constant pressure, the emulsion droplets are regulated to an aiming size. More specifically, the opening diameter of a micropore is designed in accordance with an aiming size of the emulsion droplet, and the rate of the inorganic particle-containing emulsion pass through the micropores under a constant pressure is adjusted in accordance with both the viscosity of the inorganic particle-containing emulsion and the pressure applied. When the inorganic particle-containing emulsion passes through the micropores at a constant rate, the size of the emulsion droplets passed through the micropores can be designed according to the surface tension thereof. As a result, regulation of the droplet size can be achieved.

In the method for manufacturing inorganic particles of the present invention, when the oil phase liquid constituting the inorganic particle-containing emulsion contains a dispersion stabilizer, clogging of the inorganic particle-containing emulsion in the micropores can be significantly prevented when passing through the micropores. As a result, the manufacturing method of a particle of the present invention is made to be a drastically improved method.

More specifically, the hydrophobic particle contained as a dispersion stabilizer in the inorganic particle-containing emulsion performs steric obstruction to prevent the uniting of the emulsion droplets by just before the inorganic particle-containing emulsion introduced to the micropores by an applied pressure. As a result, forming of the emulsion droplets in an excessively larger size than the micropores after passing through the micropores is prevented to result precise regulation of the droplet size in an aiming size. Further, when oil phase liquid constituting the inorganic particle-containing emulsion contains the hydrophobic particle, it is less likely to cause clogging in the micropores when passing through the micropores. It is yet to be verified, but thought that the oil phase liquid which contains the hydrophobic particle is characterized in having specific surface area and it exist between the emulsion droplets and the micropore formation material to perform as lubrication agent when the emulsion droplets passes through the micropores. As a result, the emulsion droplets may smoothly pass through the micropores without the influence of wettability of the micropore formation material surface, and then the surface tension of the emulsion droplets are maintained to prevent clogging.

As a result, material properties and surface state of a micropore formation material may not affect on the droplet size of emulsion droplets after passing through the micropores. Further, the emulsion phases may never convert when passing through the micropores by the influence of the wettability of a micropore formation material surface against to the inorganic particle-containing emulsion.

In the prior arts, the shape and size of emulsion droplets after passing through micropores tend to fluctuate affected by the surface properties of the micropore formation material through which the emulsion passes. For this reason, to manufacture aiming particles, the methods have been employed wherein the quality of micropore formation material itself is modified or a substance for improving the wettability of the micropore surface is coated before the emulsion is passed through.

However, the inorganic particle-containing emulsion of the present invention can prevent the clogging of micropore due to the contained hydrophobic particle, i.e. it does not require any special treatment on the micropore formation material or the surface state thereof. In addition, as the liquid cut-off of the emulsion from the micropore after passing though the micropores is good, emulsion droplets can be formed without utilizing a shearing force. As a result, the size of emulsion droplet formed after passing through micropores is specified in accordance with shape and size of the micropore, the rate emulsion passing through the micropore, viscosity of the emulsion, and surface tension of the emulsion. Because these values can be maintained constant, the size of emulsion droplet can be made uniform by making the emulsion pass through micropores, i.e. effective regulation of the emulsion droplets with high precision can be performed. As a result, the production method of the present invention can provide easy control for preparing emulsion droplets having aiming size and excellent in working efficiency because of clogging-free also.

In general, the emulsion may sometime show phase conversion after passing through micropores depending on the wettability condition between the micropore surface and the emulsion. However, the manufacturing method of a particle of the present invention assure maintenance of the inorganic particle-containing emulsion in a W/O emulsion state after passing through micropores. Thus, despite the particle which contains both inorganic particle and agar-agar is manufactured through the powder formation followed by the steps of desolventizing and drying, but the desolventizing and drying steps are required only to remove the moisture, so it makes carrying out of desolventizing and drying easy. As a result, the manufacturing method of a particle of the present invention can be a manufacturing method of a particle excellent in various factors required for productivity such as dispersability, droplet size regulation, easy handling in the production steps, yield, etc.

The solid content included in the inorganic particle-containing emulsion is made to be in the range from 5 to 30 wt % against to 100 wt % of the inorganic particle-containing emulsion when passing through the micropores. When the solid content is less than 5 wt %, the viscosity is too low to make regulation of the droplet size of the emulsion droplets after the emulsion passes through micropores by an applied pressure difficult. On the other hand, when the solid content is greater than 30 wt %, the viscosity may be too high tends to cause the clogging of micropores.

The mean to make the inorganic particle-containing emulsion pass through micropores may be any manner insofar as the inorganic particle-containing emulsion can be made pass through micropores with a constant pressure, in accordance with designed viscosity of the inorganic particle-containing emulsion and the shape of micropores.

First, furnish pressure vessel to store the inorganic particle-containing emulsion in which an inner wall is provided to divide inside of the vessel into the first chamber and the second chamber. The inner wall is provided with micropores. The inorganic particle-containing emulsion to be droplet size regulated is put into the first chamber of the vessel, which is then closed hermetically, and a pressure is applied by compressed air to the hermetically closed first chamber to differentiate the pressure in the first chamber from that of the second chamber. According to difference of pressure, the inorganic particle-containing emulsion is made to pass through micropores and is discharged to the second chamber. At this time, the inorganic particle-containing emulsion with droplet size regulated emulsion droplets having an aiming size can be prepared according to combination of the pass rate and the surface tension of the inorganic particle-containing emulsion.

The diameter of micropores provided in the inner wall could be 25 to 100% of the size of the emulsion droplet contained in the inorganic particle-containing emulsion after regulation without limitation on pore shape. In addition, applicable micropore diameter range can be specified to be in the range from 5 to 80 μm.

To enhance the production efficiency, it is preferable to make the vessel structure to have a plurality of micropore formed therein even one of micropore formed in the one pressure vessel is acceptable. When a plurality of micropore is provided, micropores are preferable to be arranged apart from each other at least twice the length of the micropore diameter to prevent the droplet size regulated emulsion droplets from contacting and uniting each other. Even it is characteristic of the present invention that the material of the inner wall is not limited because of performance of the hydrophobic particle, it is more preferable to make the micropore surface hydrophobic for performing smooth droplet size regulation.

step b: The inorganic particle-containing emulsion regulated in step a is chilled to make the agar-agar contained in the emulsion droplets to be a gel to prepare an inorganic particle-containing gel particle. To finish the shape of particles uniform, the inorganic particle-containing gel particle is preferred to be made to be gel in which dispersion state of inorganic particle is maintained. To result such a state, the method for chilling is preferred to carry out in such a manner that the temperature of whole the inorganic particle-containing emulsion is made to be below 40° C. at which agar-agar is made to be a gel in a short time. For example, a method wherein the vessel which stores emulsion is put into chilled water or like and any other method by which the whole inorganic particle-containing emulsion can be chilled quickly is acceptable. After finishing chilling, the emulsion should be kept for at least 3 hours. It is preferable to adjust temperature to be in the range from 0 to 40° C. while keeping, because even the viscosity of the oil phase liquid has been lowered in the chilling step, viscosity of the oil component will turn to increase and the effect to prevent the gel particles from uniting and aggregating each other may be obtained.

After chilling, the emulsion droplet contained in the water phase liquid particle is made to be a gel and the inorganic particle-containing gel particle can keep its own shape. Then, the inorganic particle-containing emulsion turns to be a suspension composed of oil and gel particle not an emulsion wherein the inorganic particle-containing gel particles are dispersed in the oil phase liquid.

step c: The oil phase liquid is removed for separation and collection of the inorganic particle-containing gel particles followed by rinsing. Because the suspension composed of oil and gel particle contains the viscosity increased oil component and hydrophobic particle, the inorganic particle-containing gel particles may be hardly settled down and mostly dispersed therein. However, the supernatant, if any, should be first removed. Next, an oleophilic organic solvent is added to the suspension composed of oil and gel particle, and then agitated. When the oleophilic organic solvent is added, the oil phase liquid and oleophilic organic solvent are co-soluble and it makes the state where the hydrophilic inorganic particle-containing gel particles are easily separated from the hydrophobic oil and hydrophobic particles.

The oleophilic organic solvent is preferred to be selected from toluene, hexane, and methyl ethyl ketone. Toluene is particularly preferable because it is inexpensive, has good co-solubility with the oil phase liquid. In addition, toluene is stained by the hydrophobic particle, i.e. it indicates that the hydrophobic particles have been removed when toluene turns to inherent clear color, making it easy to monitor the degree of the oil phase liquid removal.

After adding the oleophilic organic solvent followed by agitation, the inorganic particle-containing gel particle is made settle down, and separated and collected from the oil phase by removing the oil and hydrophobic particle. In the operation, the inorganic particle-containing gel particle is rinsed and desolventized by the repeated decantation using the oleophilic organic solvent. When toluene is used as the oleophilic organic solvent, repeating decantation until color of toluene turn to be clear can assure the sufficient removal of the oil phase liquid.

step d: The dried particles which contain both inorganic particle and agar-agar is prepared by dehydration drying of the inorganic particle-containing gel particle after separation, collection and rinsing. The dehydration drying is carried out by adding an alcohol soluble in an oleophilic organic solvent and performs the dehydration effect to remove moisture and the residual oleophilic organic solvent. More specifically, the rinsed inorganic particle-containing gel particles are made disperse in an alcohol selected from methanol, ethanol, and propanol to prepare gel particle dispersed slurry, and the moisture is absorbed by the alcohol from the inorganic particle-containing gel particles. The gel particle dispersed slurry is then subjected to the solid-liquid separation to collect the moisture-removed dehydrated particles. Subsequently, the dehydrated particles are air-dried to remove the alcohol, thereby a particle which contain both inorganic particle and agar-agar is manufactured. According to the method, the particle can be dried easily in a short time. As a result of desolventizing and rinsing, binder components such as the oleophilic organic solvent, hydrophobic particle, alcohol, oil, etc. will be a waste solution. However, the waste solutions can be reused through separation and refining.

The thus manufactured particle is a particle composed of inorganic particle as a filler and agar-agar as a binder component having an average particle size of 1 to 150 μm, and the particle size distribution is uniform. When an additive, such as a dispersant, is added to the water phase liquid in addition to the inorganic particles, the coupled particle may be a complex particle which contains such a component in addition to the inorganic particle and agar-agar.

The present invention will be described with reference to Examples and Comparative Examples, but is not limited thereto.

### EXAMPLES

Example of production method for Mn—Mg—Sr ferrite particle, a ferrite interim material according to the manufacturing method of a particle of the present invention will be demonstrated.

### <Preparation of Water Phase Liquid>

A 40 L bead mill was put 25 L water into. Then 15.55 kg of iron (III) oxide, 8.90 kg of trimanganese tetraoxide, 0.57 kg of magnesium hydroxide, 0.72 kg of strontium carbonate, and 275 g of polycarboxylic acid-type polymer surfactant having a 40% solid content as a dispersant were added to the bead mill, followed by agitation for 2 hours for mixing. 217 g of the thus prepared water slurry was extracted into a vessel, and 108 g of water was added to arrange a solid content to be 33.5%, and then 7.5 g of powder shape agar-agar (UP-37, manufactured by Ina Food Industry Co., Ltd.) was further added thereto, followed by agitation for mixing for 3 minutes using a homogenizer at 5000 rpm.

After finishing the mixing, the water slurry was heated for both dissolving the agar-agar and evaporating the water to arrange a solid content to be 40 wt %. Then, 15 g of polycarboxylic acid polymer surfactant having a 40% solid content as a dispersant was added to the water phase liquid to adjust a viscosity of the water slurry to be 100 cp or less. The water phase liquid together with the vessel was maintained at 90° C. under agitation to prevent the water phase liquid from the coagulation due to the gel formation of agar-agar.

### <Preparation of Oil Phase Liquid>

600 cc of a blended vegetable oil (salad oil, manufactured by Nisshin OilliO Group, Ltd.) having a viscosity of 100 cp at room temperature (23° C.) was put into a beaker, 18 g (about 3 wt % against to 100 wt % of a salad oil) of carbon black (MOGUL-L, manufactured by CABOT SPECIALTY CHEMICALS, INC.) was added as a dispersion stabilizer thereto and dispersed for 3 minutes using a homogenizer, and the mixture was heated up to 90° C. The viscosity of the oil phase liquid was adjusted to be 100 cp.

### <Production of Inorganic Particle-Containing Emulsion>

The water phase liquid was maintained at 90° C. while agitating by using the Full Zone Blade for a 1 L beaker, and then addition of the dropwise oil phase liquid total 600 cc was carried out slowly thereto by using a syringe. In the initial stage, the rotation of the agitator was controlled so as to make dispersion state of the added dropwise oil phase liquid and the water phase liquid uniform all the time, thereby the inorganic particle-containing emulsion is prepared.

The agitation was carried out initially in rotation of about 300 rpm, and rotation is increased in accordance with the increased viscosity of the liquid mixture as the amount of salad oil add was increased, with the upper limit of agitation being rotation of 500 rpm. And then, when the phase conversion in emulsification occurred and the W/O emulsion droplet was formed, the viscosity of mixed liquid was reduced and the rotation was also reduced in accordance. Because an agitation of too much rotation against to the viscosity of the mixed liquid tends to cause the uniting of W/O emulsion droplets, the agitation rotation was adjusted in accordance with the viscosity to assure the shape stability and dispersion of particles in the W/O emulsion.

### <Manufacturing Method of a Particle>

A compressible cylinder (volume 500 cc, inner diameter 42 mm) was furnished and in which, a filter comprising micro through pores was provided as an inner wall to divide the inner space of the cylinder to be the first chamber and the second chamber. The filter is made of stainless steel and is provided with a plurality of circular micropore penetrating in the direction of thickness having an opening diameter of 40 μm, a pitch among the openings of 150 μm, and a thickness of 100 μm.

After preheating the cylinder to 90° C., it is the temperature of the inorganic particle-containing emulsion, 400 cc of the inorganic particle-containing emulsion was put into the cylinder which was then closed hermetically. Then, the first chamber of cylinder was compressed with 0.4 MPa of compressed air to discharge particle-containing emulsion through the micropores provided in the filter to regulate the droplet size of the inorganic particle-containing emulsion. The droplet size regulated inorganic particle-containing emulsion kept in a container is immediately put into chilled water to chill together with the container to prepare a suspension composed of oil and gel particle in which the emulsion droplets were transformed to be the inorganic particle-containing gel particles. Thus prepared suspension was kept at 4° C. for 3 hours (step a).

In the droplet size regulation step, the carbon black contained in the inorganic particle-containing emulsion performs steric obstruction to prevent the uniting of the emulsion droplets by just before the inorganic particle-containing emulsion introduced to the micropores by an applied pressure. As a result, generation of the emulsion droplets in an excessively larger size than the micropores after passing through the micropores is prevented to result precise regulation of the droplet size in an aiming size. Further, when oil phase liquid constituting the inorganic particle-containing emulsion contains the hydrophobic particle, it is less likely to cause clogging in the micropores when passing through the micropores. The oil phase liquid which contains the hydrophobic particle is characterized in having specific surface area and it exist between the emulsion droplets and the micropore formation material to perform as lubrication agent when the emulsion droplet passes through the micropores. As a result, the emulsion droplet may smoothly passes through the micropores without the influence of wettability of the micropore formation material surface, and then the surface tension of the emulsion droplet is maintained to prevent clogging. In addition, as the liquid cut-off of the emulsion from the micropore after passing though the micropores is good, emulsion droplets can be formed without utilizing a shearing force.

As a result, the properties and surface state of a micropore formation material do not affect on the droplet size of emulsion droplets after passing through the micropores. Further, the emulsion phase may never be converted after passing through micropores depending on the wettability condition of the micropore surface against to the emulsion. As a result, the size of emulsion droplet formed after passing through micropores is specified in accordance with shape and size of the micropore, rate of the emulsion passing through the micropore, viscosity of the emulsion, and surface tension of the emulsion. Because these values can be maintained constant, the size of emulsion droplets can be made uniform by making the emulsion pass through micropores, i.e. effective regulation of the droplet size of emulsion droplets with high precision can be performed. As a result, the production method of the present invention can provide easy control for preparing emulsion droplets having aiming size and excellent in working efficiency because of clogging-free also.

In addition, carbon black is burned down when baked at high temperature. Consequently, when the prepared particle is baked at high temperature as in the case production of the Mn—Mg—Sr ferrite powder which is the ferrite interim material disclosed in the present Example and ceramic particles and the like in addition, the carbon black remained in the particle before baking is burned down after baking, to result no influence as an impurity.

600 cc of toluene was added to the suspension composed of oil and gel particles with agitation to make the state wherein the hydrophilic inorganic particle-containing gel particles are easily separated from the hydrophobic blended vegetable oil and carbon black. Subsequently, the decantation was carried out to remove the blended vegetable oil and carbon black, thereby separating and collecting the inorganic particle-containing gel particle. Because toluene is stained by the color of carbon black, it indicates that carbon black has been removed when toluene turns to inherent clear color, making it easy to monitor the degree of the oil phase liquid removal. The operation was repeated until toluene was not colored. The residual toluene and salad oil were then removed by filtration. After removing toluene and salad oil, the cake of inorganic particle-containing gel particles remained on the filter paper was collected and then dispersed in methanol to prepare slurry. The moisture and methanol contained in the inorganic particle-containing gel particle were removed by further filtering the slurry to prepare desolventized particle (solid).

The prepared desolventized particle was air-dried for 2 hours to thoroughly evaporate methanol, and coarse particles were removed by using an 80-mesh sieve to prepare dried particles.

The classified ferrite interim material prepared in the present Example was investigated by SEM, and the Feret's diameter was measured on 100 particles in the SEM photo. The average particle size (number average particle size) D₅₀ and standard deviation σ were calculated respectively according to the measured Feret's diameters of dried particles, and the CV value was determined as expressed in [the standard deviation σ]/[the average particle diameter D₅₀]. The result shows the average particle size of the ferrite interim material D₅₀ of 44.0 μm, the standard deviation of the particle size σ of 9.85 μm, and the CV value (σ/D50) of 0.22.

### INDUSTRIAL APPLICABILITY

In the inorganic particle-containing emulsion of the present invention, as the water phase liquid contains both inorganic particle and agar-agar and the oil phase liquid contains hydrophobic particles as a dispersion stabilizer, settling down of the inorganic particles is prevented, dispersability of the inorganic particles in emulsion is maintained, and further, inorganic particle-containing gel particles can be formed by chilling. So, it is extremely useful in the manufacturing method of a particle of the present invention. According to the manufacturing method of a particle of the present invention which uses the inorganic particle-containing emulsion of the present invention, particles including coupled inorganic particles having precisely uniform particle shape can be manufactured in less production steps and in high yield. As a result, the inorganic particle-containing emulsion and the manufacturing method of a particle of the present invention are suitable for the industry in which regulation of the particle size is required to control the particle size and particle size distribution, for example, they handles various metal powders, oxides, edible powders, pharmaceuticals, fertilizers, color materials, photosensitive material, perfumes, cosmetics, etc.

1. An inorganic particle-containing emulsion which is a water in oil emulsion prepared by mixing an oil phase liquid and a water phase liquid which contains an inorganic particle under agitation, characterized in that
the water phase liquid contains an inorganic particle having a specific gravity of 1.5 to 11 g/cm³ and 0.5 to 5 wt % of an agar-agar against to 100% of a water contained in the water phase liquid;
the oil phase liquid contains a hydrophobic particle as a dispersion stabilizer; and
the inorganic particle is made disperse by making the water phase liquid to be a dispersion phase in the water in oil emulsion.

2. The inorganic particle-containing emulsion according to claim 1, wherein the hydrophobic particle is carbon black, hydrophobilized silica, or hydrophobilized titanium oxide.

3. The inorganic particle-containing emulsion according to claim 2, wherein the carbon black has a BET specific surface area of 200 m²/g or less and an oil absorption ratio of 100 cc/g or less, and is added in an amount of 0.5 to 10 wt % against to 100% of an oil weight in the oil phase liquid.

4. The inorganic particle-containing emulsion according to claim 1, which is prepared by adding the oil phase liquid to the water phase liquid gradually under agitation to cause a phase conversion emulsification from oil in water emulsion to water in oil emulsion.

5. The inorganic particle-containing emulsion according to claim 1, wherein the inorganic particle is one kind or more kinds of an inorganic particle and has an average particle size of 0.01 to 5 μm.

6. A manufacturing method of the particles which contain both inorganic particle and agar-agar by using the inorganic particle-containing emulsion according to claim 1, characterized in that the process comprises the steps of:
passing of the inorganic particle-containing emulsion through micropores under a constant pressure for size regulation of the emulsion droplets contained in the inorganic particle-containing emulsion;
chilling of the droplet size regulated inorganic particle-containing emulsion to make the emulsion droplets gel and prepare a suspension composed of the inorganic particle-containing gel particles and an oil phase liquid which contains a dispersion stabilizer; and
removing of the oil phase liquid for separation and collection of the inorganic particle-containing gel particles, followed by rinsing and dehydration-drying of the collected particles to manufacture particles which contain both inorganic particle and agar-agar.

7. The manufacturing method of the particle according to claim 6, wherein in the separation to collect the inorganic particle-containing gel particles, an oleophilic organic solvent is added to the suspension under agitation to cause the settling down of the inorganic particle-containing gel particles, and then the inorganic particle-containing gel particles are separated and collected from the oil phase liquid.

8. The manufacturing method of the particle according to claim 7, wherein the oleophilic organic solvent is toluene, hexane, or methyl ethyl ketone.

9. The manufacturing method of the particle according to claim 6, wherein the dehydration-drying process comprises the steps of:
dispersing of the rinsed inorganic particle-containing gel particles in an alcohol selected from the group consisting of methanol, ethanol and propanol to prepare a gel particle dispersed slurry,
removing of the moisture contained in the inorganic particle-containing gel particles by the alcohol,
subjecting of the gel particle dispersed slurry to the solid-liquid separation to collect the moisture-free dehydrated particles, and
removing of the alcohol from the dehydrated particles by air-drying to manufacture particles which contain both inorganic particle and agar-agar.

10. The manufacturing method of a particle according to claim 6, wherein a solid content of the inorganic particle-containing emulsion to be passed through micropores is 5 to 30 wt % against to 100% of the inorganic particle-containing emulsion.
